(19) United States
(12) Patent Application Publication
(10) Pub. No.: US 2022/0363367 A1
(43) Pub. Date: Nov. 17, 2022

(54) AIRCRAFT PROPULSION SYSTEM

(71) Applicant: Pyka Inc., Oakland, CA (US)

(72) Inventor: Michael Norcia, Berkeley, CA (US)

(21) Appl. No.: 17/741,663

(22) Filed: May 11, 2022

Related U.S. Application Data
(60) Provisional application No. 63/188,998, filed on May 14, 2021.

(51) Int. Cl. B64C 11/48; B64C 11/28; B64D 27/26

(52) U.S. Cl. CPC B64C 11/48; B64C 11/28; B64D 27/26; B64D 27/24

(57) ABSTRACT

An aircraft having a fuselage with one or more wings coupled to the fuselage. A pair of booms are attached to the one or more wings. Each boom has a front end coupled with a front propulsion system and a rear end coupled with a rear propulsion system. Each front propulsion system includes a front motor coupled with a foldable front propeller in a tractor configuration. Each rear propulsion system includes a rear motor coupled with a foldable rear propeller in a pusher configuration.

### CROSS-REFERENCE TO RELATED APPLICATIONS

This application claims the benefit of U.S. Application No. 63/188,998, filed May 14, 2021, which is hereby incorporated by reference in its entirety.

### BACKGROUND

Aircraft can be used to perform tasks such as transportation, cargo delivery, and other tasks. Some aircraft have a propulsion system comprising motor-driven propellers. The blade pitch of a propeller affects its efficiency at different airspeeds. A propeller with a steeper blade pitch can have peak efficiency at a relatively high airspeed, such as for cruising, while a shallower blade pitch can be more efficient at lower airspeeds typical of takeoff and climb-out. Further considerations in aircraft efficiency are the effect of the propeller on airflow over the wing or body of the aircraft and reducing frontal area to reduce drag. An aircraft propulsion system configured to take advantage of a shallower propeller blade pitch during takeoff and climb-out and a steeper propeller blade pitch during cruise is desirable to increase the efficiency of the propulsion system. Moreover, design considerations to provide an aerodynamic design and reduce frontal area and drag would also be desirable.

### SUMMARY

One embodiment of an aircraft comprises a fuselage, one or more wings coupled with the fuselage, a pair of booms attached to the one or more wings, each boom having a front end coupled with a front propulsion system and a rear end coupled with a rear propulsion system, each front propulsion system comprising a front motor coupled with a foldable front propeller in a tractor configuration, and each rear propulsion system comprising a rear motor coupled with a foldable rear propeller in a pusher configuration.

In one embodiment, the blade pitch of the foldable front propellers is shallower than the blade pitch of the foldable rear propellers. In one embodiment, both the front propulsion systems and rear propulsion systems are configured to be powered during takeoff and climb-out and only the rear propulsion systems are configured to be powered during cruise. In one embodiment, only the front propulsion systems are configured to be powered during landing.

In one embodiment, each front motor is inline with the corresponding rear motor on the respective boom. In one embodiment, each boom further comprises an air cooling system including an air cooling path running from the front motor of the boom through a support tube to the rear motor of the boom. In one embodiment, each boom is removable from the one or more wings. In one embodiment, each boom comprises a top portion and a bottom portion, the bottom portion is attached to the underside of the one or more wings, and the top portion is coupled with the top side of the one or more wings and the bottom portion of the boom. In one embodiment, the front end of each boom has a diameter that is the same size or smaller than the diameter of the front motor and the rear end of each boom has a diameter that is the same size or smaller than the diameter of the rear motor.

In one embodiment, the aircraft includes a safety system configured to detect when the rear propellers are in a folded configuration and emit a signal upon the detection to allow a door of the aircraft to be opened.

On embodiment of a method of operating an aircraft includes flying the aircraft on a flight path. In one embodiment, a method of operating an aircraft includes flying the aircraft in takeoff, climb-out, and cruise phases of flight, powering both the front propulsion systems and rear propulsion systems during takeoff and climb-out phases, and powering only the rear propulsion systems during the cruise phase. In one embodiment, a method of operating an aircraft includes flying the aircraft in a landing phase of flight and powering only the front propulsion systems during the landing phase.

### BRIEF DESCRIPTION OF THE DRAWINGS

FIGS. 1A-1B illustrate an example aircraft according to an embodiment.

FIG. 2 illustrates a block diagram of exemplary systems of an aircraft according to an embodiment.

FIGS. 3A-3B illustrate an example propeller that may be used in an aircraft in the unfolded and folded configurations, respectively, according to an embodiment.

FIG. 4 illustrates an example diagram of how the front and rear motors of an aircraft may be used at different phases of a flight according to an embodiment.

FIG. 5 illustrates an example air cooling system for front and rear motors according to an embodiment.

FIGS. 6A-6B illustrate an example aircraft in a parked configuration on the ground according to an embodiment.

FIG. 7 illustrates an example method that may be used to attach and detach a boom from an aircraft according to an embodiment.

FIG. 8 illustrates an exemplary method that may be used by a safety system to automatically lock and unlock a safety lock of an aircraft according to an embodiment.

FIG. 9 illustrates an exemplary method that may be used for an aircraft to takeoff and climb-out to cruising altitude according to an embodiment.

FIG. 10 illustrates an exemplary method that may be used for an aircraft to land according to an embodiment.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

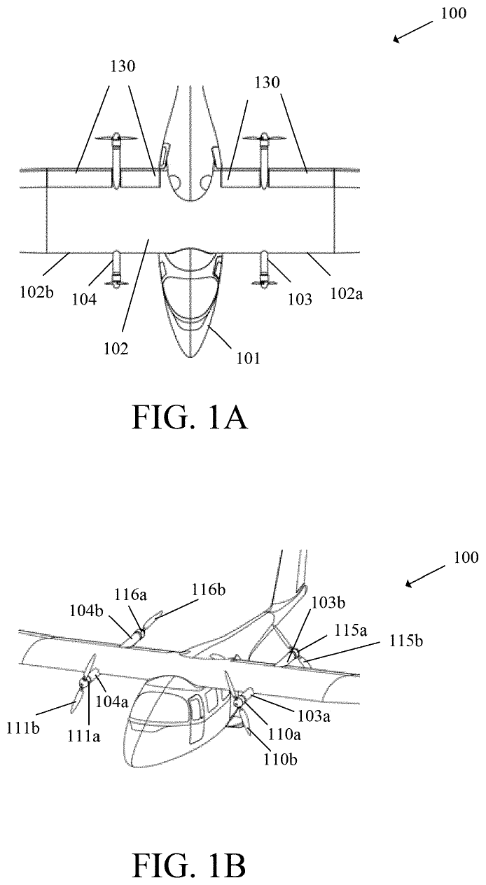

FIGS. 1A-1B illustrate an example aircraft. In one embodiment, a fixed-wing aircraft 100 may have a fuselage 101 coupled to a wing 102 with left and right wing sections 102a, 102b. The fuselage 101 may have any shape, size, or aerodynamic characteristics and the wing 102 may have any shape, span, sweep angle, size, or airfoil characteristics. Wing 102 is illustrated coupled at a high attachment point to the fuselage 101 but may be coupled at any point to the fuselage 101 such as at the midpoint, below the fuselage 101, or any other point. Aircraft 100 may have a pair of booms 103, 104 attached to the left and right wing sections 102a, 102b, respectively, each boom 103, 104 having a front end 103a, 104a coupled with a front propulsion system and a rear end 103b, 104b coupled with a rear propulsion system. Each front propulsion system may comprise a front motor 110a, 111a coupled with a foldable front propeller 110b, 111b in a tractor configuration (e.g., the propeller is in front of the motor). Each rear propulsion system may comprise a rear motor 115a, 116a coupled with a foldable rear propeller 115b, 116b in a pusher configuration (e.g., the propeller is behind the motor).

In other embodiments, aircraft 100 may have a pair of separate left and right wings on the left and right side of the fuselage 101, respectively. The left and right wings may have any shape, span, sweep angle, or size. Booms 103, 104 with front and rear propulsion systems may be attached to the left and right wing, respectively.

In one example, aircraft 100 is electric-powered with four electric motors 110a, 111a, 115a, 116a in a push-pull configuration. The aircraft 100 has two pairs of push-pull propulsion systems each associated with a boom 103, 104, each comprising a front motor 110a, 111a in a tractor configuration (e.g., pull configuration) and a rear motor 115a, 116a in a pusher configuration. The booms 103, 104 may comprise composite and be formed by bonding together front end 103a, 104a and rear end 103b, 104b. The booms 103, 104 may comprise metallic motor mounts on their front tips and rear tips for mounting each of the electric motors 110a, 111a, 115a, 116a. The electric motors may be powered by a battery system onboard the aircraft 100. The battery system may be located anywhere in the airframe such as in the fuselage 101 or wing 102. Locating the battery system in the wing 102 may be preferable so that the power source is near the motors. The aircraft 100 and booms 103, 104 may comprise any material types such as composite, plastic, metal, aluminum, wood, and other materials.

Aircraft 100 may have any number of booms, each comprising a push-pull propulsion system with one motor in tractor configuration and one motor in pusher configuration. In one example, aircraft 100 has two booms on each side of the fuselage providing four front motors and four rear motors in total. Aircraft 100 may have one boom, two booms, three booms, or any number of booms on each side of the fuselage.

In addition, aircraft 100 may have a plurality of control surfaces 130 on wing 102. In one example, control surfaces are located between the booms 103, 104 and the fuselage 101 and between the booms 103, 104 and the tip of the wing 102. Control surfaces 130 may be located on the trailing edge of the wing 102 and may comprise flaps, ailerons, and other control surfaces. In addition, aircraft 100 may have a cockpit with cockpit controls for piloting the aircraft. One or more cockpit doors may enable entry to the cockpit.

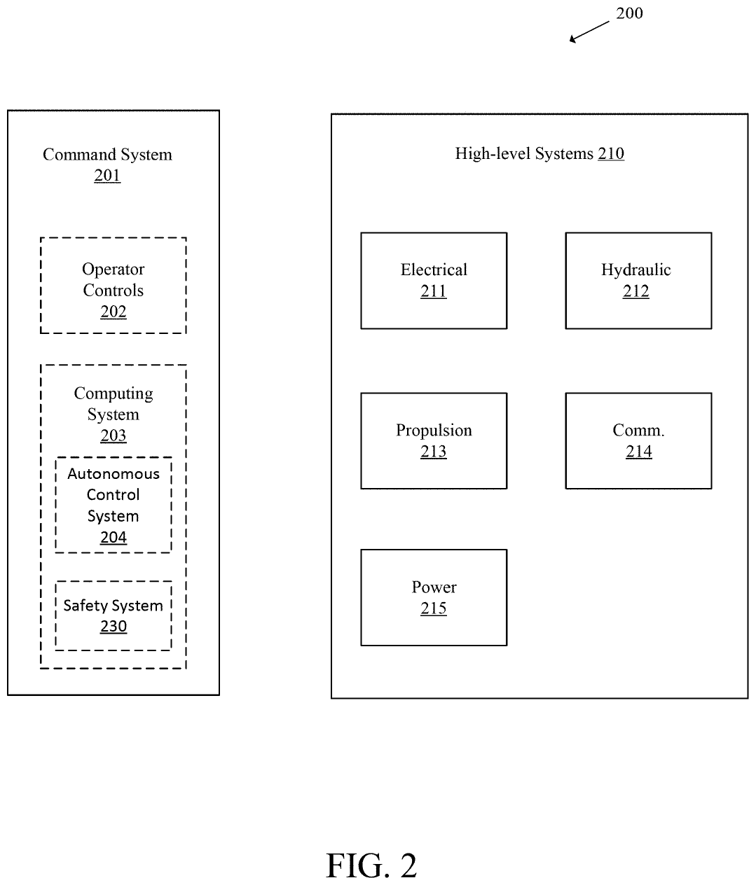

FIG. 2 illustrates a block diagram of exemplary systems 200 of aircraft 100 for implementing the features and processes described herein. In an embodiment, aircraft 100 includes a command system 201 for controlling the operation of the aircraft by issuing commands to other high-level systems 210. The command system 201 may comprise operator controls 202 for manual operation by a pilot. Operator controls 202 may be cockpit controls in a cockpit of the aircraft 100. Alternatively, operator controls 202 may be external to aircraft 100 for control by a ground operator, such as when aircraft 100 is an unmanned aerial vehicle (UAV). Operator controls 202 may comprise a remote control or radio control system. In an embodiment, the command system 201 may comprise a computing system 203. Computing system 203 may be a system of one or more processors, graphics processors, I/O subsystem, logic circuits, analog circuits, associated volatile and/or non-volatile memory, associated input/output data ports, power ports, etc., and/or one or more software programs executing on one or more processors or computers. Computing system 203 may comprise an autonomous control system 204 for controlling the operation of the aircraft by issuing commands to other high-level systems 210 without a human pilot. The autonomous control system 204 may be an artificial intelligence computer system or software program. The autonomous control system 204 may receive as input signals from sensors such as altitude, position, orientation, and so on and, based on those signals, determine commands to issue to high-level systems 210. Computing system may further comprise a safety system 230 for implementing automated safety features of aircraft 100.

Example high-level systems 210 include, but are not limited to, an electrical system 211, a hydraulic system 212, a propulsion system 213, a communications system 214, a power system 215, and other systems. Additionally, high-level systems may include other systems and components to perform the operations described herein.

Electrical system 211 comprises systems for performing electrical operations of the aircraft 100, such as operating internal and external lights, electronic instruments and controls, electric motor controls, and other systems. In an embodiment, electrical system 211 may include a fly-by-wire system for interpreting commands from the command system 201 and transmitting them as electrical signals to control surfaces 130 of the aircraft 100.

Hydraulic system 212 comprises systems for use of hydraulics on the aircraft 100. In an embodiment, hydraulic system 212 may be used for extending and retracting landing gear, moving control surfaces 130, and other operations.

Propulsion system 213 comprises systems for propelling the aircraft 100. Propulsion system 213 includes front propulsion systems, such as front motors 110a, 111a and front propellers 110b, 111b, and rear propulsion systems, such as rear motors 115a, 116a and rear propellers 115b, 116b. Preferably, propulsion system 213 comprises electric motors and propellers. Alternatively, propulsion system 213 may comprise internal combustion engines, jet engines, or other systems of propulsion.

Communications system 214 comprises systems for communication. In an embodiment, communications system 214 may include systems for communicating with ground control and/or other aircraft. Additionally, in an embodiment with an external, ground-based pilot of the aircraft 100, the communications system 214 may wirelessly interface with the operator controls 202 of the ground-based pilot. The communications system 214 may receive signals encoding commands from the ground-based pilot and transmit the pilot's commands to the command system 201 and/or high-level systems 210 to operate the aircraft 100.

Power system 215 comprises systems for powering the aircraft 100. In a preferred embodiment, the power system 215 comprises a battery system. Alternatively, power system 215 may comprise any form fuel, such as aviation fuel.

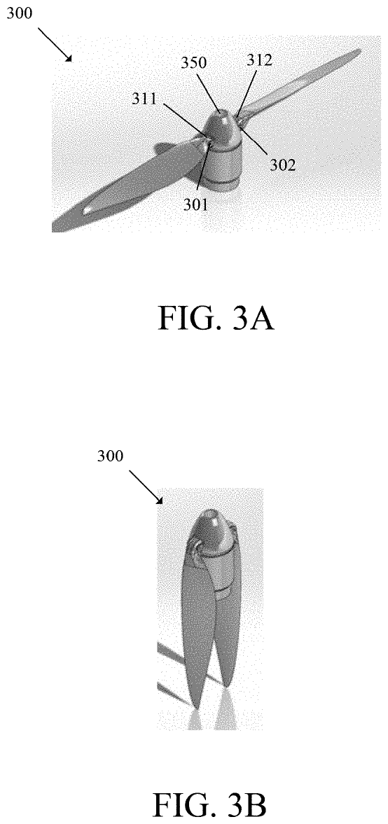

FIGS. 3A-3B illustrate an example propeller 300 used in aircraft 100 in the unfolded and folded configurations, respectively. In one example, propellers 300 are fixed pitch folding propellers. A fixed pitch propeller has a fixed blade pitch, in contrast to a variable pitch propeller where the blade pitch may be changed. Advantages of fixed pitch propellers are typically simpler design and lighter weight. Nonetheless, different blade pitches have different levels of efficiency at different air speeds. A propeller with a steeper blade pitch can have peak efficiency at a relatively high airspeed, such as for cruising, while a shallower blade pitch can be more efficient at lower airspeeds typical of takeoff and climb-out.

In one embodiment, the blade pitch of the foldable front propellers 110b, 111b is shallower than the blade pitch of the foldable rear propellers 115b, 116b. In one embodiment, both the front propulsion systems and rear propulsion systems are configured to be powered during takeoff and climb-out and only the rear propulsion systems are configured to be powered during cruise. In one embodiment, only the front propulsion systems are configured to be powered during landing. Alternatively, both the front propulsion systems and rear propulsion systems are configured to be powered during landing.

In one mode of operation, the front propellers 110b, 111b are configured for use during takeoff and climb-out, such as by having a shallow blade pitch. Other characteristics of the front propellers 110b, 111b may also be configured for use during takeoff and climb-out, such as the diameter of the propellers, power and type of the motor, and so on. The rear propellers 115b, 116b are configured for use during cruise, such as by having a steep blade pitch. Other characteristics of the rear propellers 115b, 116b may also be configured for use during cruise, such as the diameter of the propellers, power and type of the motor, and so on. In one embodiment, the front propellers 110b, 111b and rear propellers 115b, 116b have the same diameter and the front motors 110a, 111a and rear motors 115a, 116a are of the same type and design (e.g., identical) and are run at the same number of revolutions per minute (RPM). The front propellers 110b, 111b have a shallower blade pitch and the rear propellers 115b, 116b have a steeper blade pitch thereby configuring them for peak efficiency during takeoff/climb-out and cruise, respectively. When two propellers are the same diameter and are driven by the same type of motor at the same RPM, then the propeller with a steeper blade pitch will hit its peak efficiency at a relatively higher airspeed typical of cruise, while a propeller with shallower blade pitch will hit its peak efficiency at a relatively lower airspeed typical of takeoff and climb-out. Alternatively, the front propellers 110b, 111b and rear propellers 115b, 116b may have different diameters, and the front motors 110a, 111a and rear motors 115a, 116a may be of a different type and/or design (e.g., not identical) and/or are run at a different number of revolutions per minute (RPM). The front propellers 110b, 111b and rear propellers 115b, 116b may rotate in the same direction or may rotate in opposite directions (e.g., counter-rotate).

In one embodiment, the propellers 300 are passive fixed pitch folding propellers. Since the propellers 300 are passive, the propeller 300 itself does not include powered mechanisms and does not require electrical, hydraulic, or other active mechanisms in the propeller 300 to perform the folding or other functions. As fixed pitch propellers, the propellers 300 also do not have powered mechanisms to change blade pitch. In one example, the propellers 300 are spring loaded so that the propellers 300 automatically fold backward (e.g., in the opposite direction of the propeller hub 350 and toward the wing 102) into a folded configuration when not being rotated by the motors. The propellers 300 include a hinge 301, 302 at the root of each propeller blade near the hub 350. Each hinge includes a spring 311, 312 that applies a force pushing the respective propeller blade backward into a folded configuration. When propellers 300 are powered by the motors and are rotating, the angular velocity pushes the propeller blade tips outward perpendicular to the axis of rotation (e.g., commonly referred to as centrifugal force) and causes the propellers 300 to unfold into the unfolded or extended configuration. When it is desired to fold the propellers 300, the respective motors of the propellers 300 may be braked and the propellers 300 fold into the folded configuration as the rotation of the propellers 300 stops.

In one embodiment, the propellers 300 may be rotated to a specific position in their rotational path when they are stopped, so that they are stowed (e.g., folded) at the specific location, which in some embodiments could increase aerodynamic performance. In alternative embodiments, the propellers 300 may be folded and unfolded by an active (e.g., powered) mechanism. In one example, the propellers 300 may include a hydraulic or electric motor-powered mechanism to push the propellers 300 into an unfolded configuration and/or retract them into a folded configuration. Additionally, in an alternative variation, the propellers 300 may be variable pitch and may have their blade pitch adjusted by a hydraulic or electric motor-powered mechanism or by manual adjustment on the ground. The propellers 300 are illustrated with two blades, but propellers 300 may have any number of blades.

In one embodiment, the front end of boom 103a, 104a extends in front of the leading edge of wing 102 by a length greater than the length of a blade of the front propeller 110b, 111b (or greater than half the diameter of the front propeller 110b, 111b) so that the propeller blades may fold backwards by 90 degrees or more without the blade tips touching the leading edge of wing 102. The rear ends of the boom 103b, 104b extend beyond the trailing edge of the wing 102. The rear propeller blades 115b, 116b may fold aft away from the wing 102 towards the tail by 90 degrees or more.

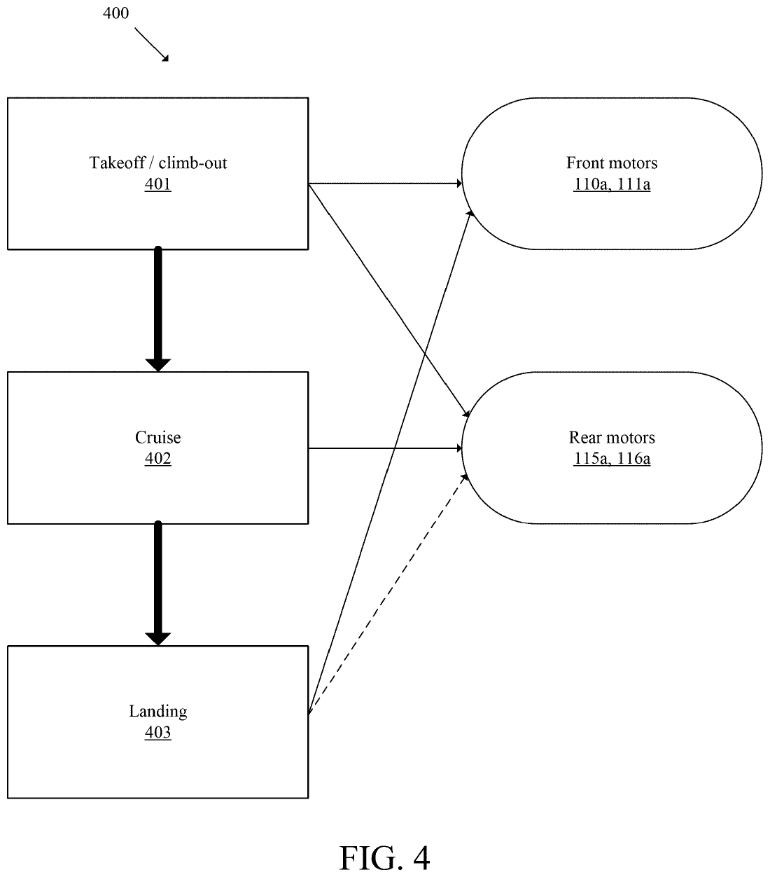

FIG. 4 illustrates an example diagram of how the front and rear motors of the aircraft 100 may be used at different phases of a flight. In an initial phase of the flight, the aircraft 100 takes off and climbs-out to cruising altitude (step 401). During this stage, the front motors 110a, 111a and the rear motors 115a, 116a may be powered (e.g., active). The determination of which motors are powered at any point in the flight plan may be determined manually by a pilot (either onboard or ground-based) or automatically. Likewise, the pilot or an automatic system may determine to slow the propeller down and stop the propeller from spinning. For example, the system may actively brake the electric motors at any time.

In one embodiment, the operator controls 202 may include a selector that allows selecting between a plurality of modes, such as “Forward propellers only,” “Rear propellers only,” or “Both forward and rear propellers.” In response to manipulation of the selector by the pilot, the respective mode of powering the motors may be initiated by sending a signal from the command system 201 to the motors 110a, 111a, 115a, 116a. The operator controls for selecting between modes may be a physical selector or a digital selector, such as a user interface on a screen, a voice-based control system, augmented reality, virtual reality, or any other digital control. In one embodiment, the determination of which motors are powered may be performed semi-automatically based on other pilot inputs that are associated with different phases a flight. For example, when the flap selector has been put into a configuration appropriate for takeoff or climb-out, then the front motors 110a, 111a and rear motors 115a, 116a may be powered. When the flap selector is in the cruise configuration and the throttle is below a threshold throttle position (e.g., 50% throttle), then only the rear motors 115a, 116a may be powered. The operator controls 202 for flaps and throttle may be directly linked to the motor controls to determine which motors are powered, or computing system 203 may monitor pilot inputs and/or the configuration of operator controls 202 to determine commands to issue to power on or power down different motors. In one embodiment, aircraft 100 is an autonomous aircraft driven by an autonomous control system 204, and the autonomous control system 204 may track the state of the flight internally in a flight control system. The determination of which motors to power is performed by the autonomous control system 204 based on the state of the flight control system. When the aircraft is in the takeoff/climb-out state, then both the front and rear motors 110a, 111a, 115a, 116a are powered, and when the aircraft is in the cruise state, then only the rear motors 115a, 116a are powered. The autonomous control system 204 may automatically update its state in the flight control system during the flight based on inputs to its sensors as well as based on actions performed by the autonomous control system 204.

Once cruising altitude is reached, the aircraft enters the cruise phase of the flight (step 402). The front motors 110a, 111a are actively braked, which causes the front propellers 110b, 111b to fold, and only the rear motors 115a, 116a are powered. The determination of braking the front motors 110a, 111a and powering the rear motors 115a, 116a for cruise may be determined by any of the manual or automatic methods described herein. Once the aircraft 100 approaches its destination, the aircraft may enter the landing phase during which it slows its velocity and decreases altitude to land (step 403). In the landing phase, the front motors 110a, 111a are powered causing the front propellers 110b, 111b to unfold, and the rear motors 115a, 116a may be optionally powered along with the front motors 110a, 111a, where both sets of motors are used for landing. During the landing phase, the control surfaces of the wing 102 such as the flaps may be deployed, and rear motors 115a, 116a may decrease performance of the wing 102 when they are powered with control surfaces deflected in front of them. In one mode, during landing, the rear motors 115a, 116a may be actively braked causing the rear propellers 115b, 116b to fold, so that only the front motors 110a, 111a are used for landing. The determination of powering the front motors 110a, 111a and the optional braking the rear motors 115a, 116a for landing may be determined by any of the manual or automatic methods described herein. One advantage of designs described herein is that by using two types of folding propellers that are optimized for different phases of flight, the aircraft 100 may achieve more optimized performance during both takeoff/climb-out and cruise without the need for variable pitch propellers, which can be more complex.

Additional benefits of the folding configuration of the propellers 300 is that by not powering the front propellers 110b, 111b during cruise those propellers stay folded, which reduces aircraft drag as laminar flow can be maintained over the entirety of the wing 102, including areas of the wing behind the front propellers 110b, 111b and in front of rear propellers 115b, 116b. Only the rear propellers 115b, 116b may be powered during cruise and since the rear propellers 115b, 116b do not blow over any part of the aircraft 100 then blockage losses are reduced.

In the event of an inflight emergency situation, such as the loss of one or more motors, then additional motors may be powered. For example, if a rear motor 115a, 116a is lost during cruise, then one or more front motors 110a, 111a may be powered during cruise to allow for an emergency landing.

In one embodiment, the front motors 110b, 111b are inline with the respective rear motors 115b, 116b that are located on the same boom. Each front motor 110b, 111b may be located directly in front of the respective rear motor 115b, 116b in the longitudinal direction. For example, booms 103, 104 may be straight booms that are positioned parallel to the fuselage 101 and perpendicular to the wing 102, such that that the front motors 110b, 111b are directly in front of the respective rear motors 115b, 116b. In one embodiment, the front motors 110b, 111b may be the same size as or larger than the rear motors 115b, 116b. The frontal area of aircraft 100 may be minimized by placing the front motors 110b, 111b inline with the respective rear motors 115b, 116b so that the rear motors 115b, 116b do not form additional frontal area of the aircraft 100, which reduces drag. In an alternative embodiment, the front motors 110b, 111b and rear motors 115b, 116b may be offset so that they are not inline and the rear motors 115b, 116b may form additional frontal area of the aircraft.

In one embodiment, the front end of each boom 103a, 104a has a diameter that is the same size or smaller than the diameter of the respective front motors 110a, 111a and the rear end of each boom 103b, 104b has a diameter that is the same size or smaller than the diameter of the respective rear motors 115a, 116a. The illustrated cylindrical booms 103, 104 may have a lateral diameter that is the same size or smaller than the front-facing diameter of the respective front motors 110a, 111a and the rear-facing diameter of the respective rear motors 115a, 116a. The booms 103, 104 are illustrated as cylindrical but may be of any shape, such as ellipsoid, cuboid, polyhedral, irregular shapes, or any other shape. The booms 103, 104 may have a size and dimension to not extend beyond the front motors 110a, 111a and rear motors 115a, 116a and form no additional frontal area of the aircraft 100 beyond the motors. By having the lateral dimensions of booms 103, 104 be the same size or smaller than the lateral dimensions of the front motors 110a, 111a and the lateral dimensions of rear motors 115a, 116a then aircraft drag may be reduced. Alternatively, the booms 103, 104 may have a larger lateral size and dimension and extend beyond the front motors 110a, 111a and rear motors 115a, 116a in the lateral direction of the aircraft 100 and form additional frontal area of the aircraft 100.

The design of several preferred embodiments has been described wherein the front motors 110a, 111a are configured for takeoff/climb-out and the rear motors 115a, 116a are configured for cruise. In alternative embodiments, different subsets of the motors can be used for takeoff/climb-out or cruise. For example, the rear motors 115a, 116a may be configured for takeoff/climb-out, such as by having propellers 115b, 116b with a shallower blade pitch, while the front motors 110a, 111a may be configured for cruise, such as by having propellers 110b, 111b with a steeper blade pitch. Alternatively, some front motors 110a, 111a and some rear motors 115a, 116a may be configured for takeoff/climb-out, such as by having propellers with a shallower blade pitch, while a different set of front motors 110a, 111a and rear motors 115a, 116a may be configured for cruise, such as by having propellers with a steeper blade pitch. In one embodiment, a first set of propulsion systems are configured for peak efficiency at a relatively lower airspeed and are configured to be powered during takeoff and climb-out, and a second set of the propulsion systems are configured for peak efficiency at a relatively higher airspeed and are configured to be powered during takeoff, climb-out, and cruise. In one embodiment, the first set of propulsion systems is also configured to be powered during landing. Alternatively, both the first and second sets of propulsion systems are configured to be powered during landing.

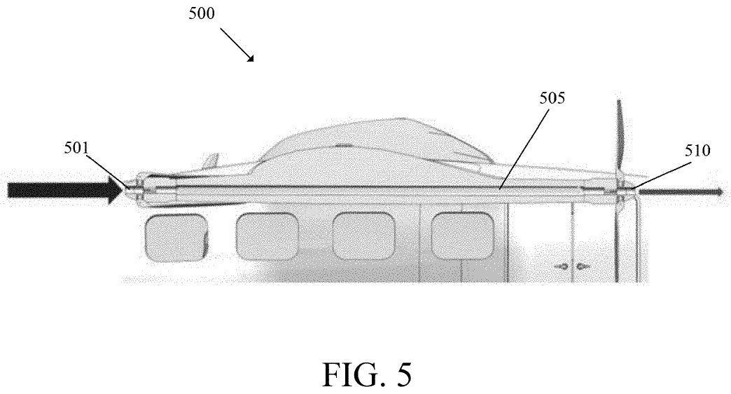

FIG. 5 illustrates an example air cooling system 500 that may be used in embodiments herein. In one embodiment, each boom 103, 104 further comprises an air cooling system 500 including an air cooling path running from the front motor 110a, 111a of the boom 103, 104 through a support tube 505 to the rear motor 115a, 116a of the boom 103, 104. In one example, cooling airflow is ducted through the front motor 110a, 111a via intake ducts 501 and flows through a primary cooling path running down the center of the motor 110a, 111a to air cool it. The cooling airflow flows from the primary cooling path of the front motor 110a, 111a through support tube 505 located inside the boom 103, 104. The support tube may be a separate tube structure or may be a hollow interior area of the boom 103, 104. The cooling airflow exits the support tube 505 and flows through the primary cooling path running down the center of the rear motor 115a, 116a to air cool it. The cooling airflow exits the rear motor 115a, 116a through the exhaust ducts 510. Air cooling system 500 may provide aerodynamic advantages. It is more aerodynamically efficient to locate two heat sources in series sharing the same cooling airflow rather than locate them in parallel. The total cooling drag of the aircraft 100 may be reduced compared to a configuration using only front motors along the leading edge of the wing 102 or only rear motors along the trailing edge of the wing 102.

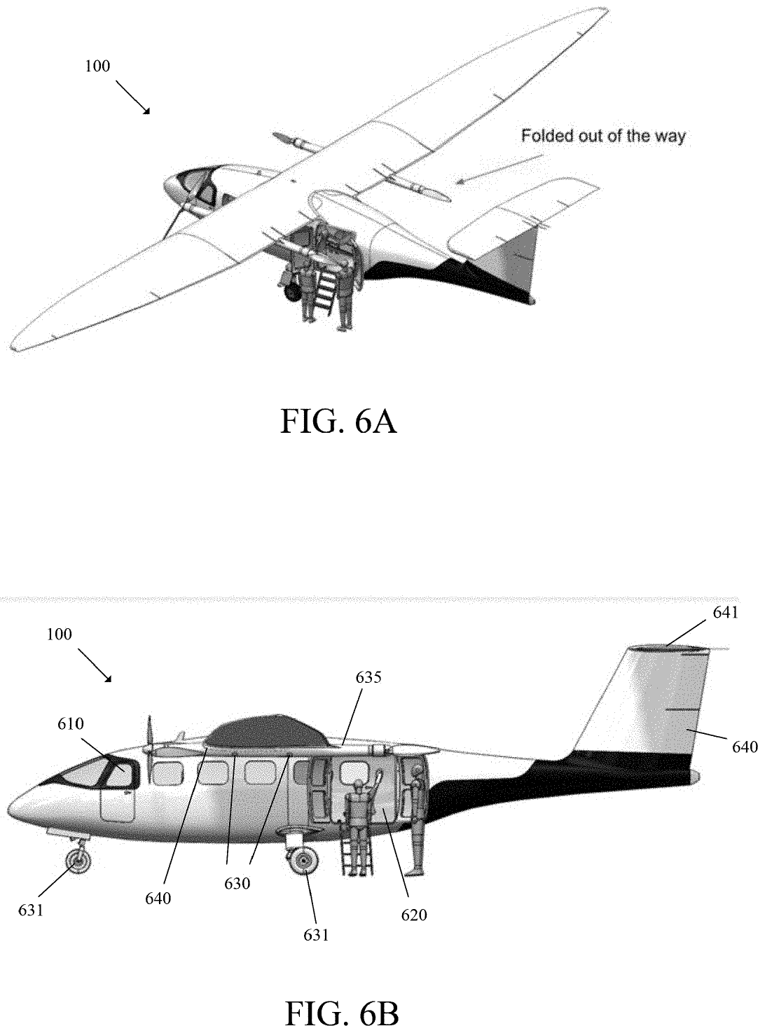

FIGS. 6A-B illustrate an example of aircraft 100 in a parked configuration on the ground. Doors 610, 620 may be opened to access the interior of the aircraft 100. Front door 610 may allow for entry to the cockpit in a piloted embodiment. Rear door 620 may be a cargo or loading door for entry to main compartment, which may be, for example, a cargo hold or cabin. The aircraft 100 includes a tail assembly (e.g., empennage) comprising a tail fin 640 and horizontal stabilizer 641. The aircraft 100 further comprises landing gear 631, which may be fixed, retractable, or any other type of landing gear. The propellers 110b, 111b, 115b, 116b are in a folded configuration because they are at rest while the aircraft 100 is parked on the ground. In one embodiment, the propellers 110b, 111b, 115b, 116b are spring loaded and fold backwards into a folded configuration automatically when they are not being rotated, such as when parked. In the alternative, propellers 110b, 111b, 115b, 116b may have an active mechanism for folding, which may be triggered by operator controls 202 or autonomous control system 204 during flight or on the ground.

Positioning propellers 110b, 111b, 115b, 116b in a folded configuration during ground handling can have several advantages. First, in a folded configuration, the propellers 110b, 111b, 115b, 116b will not auto-rotate in windy conditions, which can create a hazard such as when the aircraft 100 is being loaded or unloaded. Second, the folded propellers 110b, 111b, 115b, 116b are less obstructive and dangerous to personnel on the ground. In a high wing configuration as shown in FIGS. 6A-6B, the propellers 110b, 111b, 115b, 116b may be above head height when folded. If the propellers 110b, 111b, 115b, 116b were unfolded, it would be possible for personnel to accidentally run into the propeller 110b, 111b, 115b, 116b which could cause injury to personnel or damage to the propeller. Third, in a folded configuration, the propellers 110b, 111b, 115b, 116b are more likely to be clear of ground support equipment. For example, in the illustrated high wing configuration, ground support equipment can approach the rear door 620 from many different angles during cargo or passenger loading. If the propellers 110b, 111b, 115b, 116b were unfolded, they could collide with the ground support equipment causing damage to the aircraft and the equipment. Fourth, the folded propellers 110b, 111b, 115b, 116b are out of the way of the front and rear doors 610, 620 and leave room for them to open and close. If the propellers 110b, 111b, 115b, 116b were unfolded, the front and rear doors 610, 620 could interfere with the propeller blades when being opened and closed.

In one embodiment, the booms 103, 104 are attachable and detachable from the aircraft wing 102. In one example, the booms 103, 104 are attached to the wing by attachment points 630. Attachment points 630 may comprise any mechanisms of attachment such as bolts, screws, clamps, magnets, plugs, and any other forms of attachment or fastening. In one example, the attachment points 630 comprise metallic hardpoints where the boom 103, 104 may be bolted to main spars of the wing 102. In an embodiment, each boom 103, 104 comprises a top portion 635 and a bottom portion 640, the bottom portion 640 is attached to the underside of the wing 102, and the top portion 635 is coupled with the top side of the wing 102 and the bottom portion 640 of the boom. The top portion 635 may be a relatively smaller portion that comprises only the portion of the boom that is on top of the trailing edge of wing 102, while the bottom portion 640 comprises the rest of the boom. The removeable booms 103, 104 may enable the aircraft 100 to be more easily disassembled for shipment to other locations. In one embodiment, the entire aircraft 100, including the fuselage 101, wing 102, booms 103, 104, and propellers 110b, 111b, 115b, 116b and motors 110a, 111a, 115a, 116a may be disassembled to fit into a standard-sized shipping container (e.g., 40 ft×8 ft×8.5 ft).

Optionally, a plurality of different types of booms may be configured for different types of missions or different desired performance characteristics. Booms may be switched out based on their configurations. In one example, one of the plurality of types of booms may be selected based on the desired mission or performance characteristics of the boom. The currently attached boom may be detached from the wing 102 and the selected boom may be attached to the wing 102 instead. For example, one type of boom could be configured to have higher power by having higher power motors or propellers configured for peak efficiency at lower airspeeds to enable shorter takeoff and landing but with a lower payload.

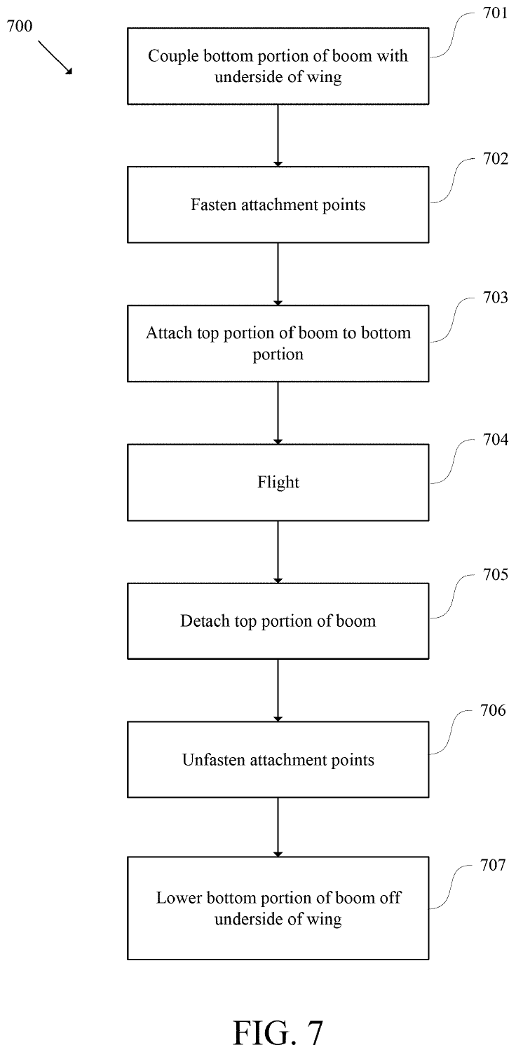

FIG. 7 illustrates an example method 700 that may be used to attach and detach a boom 103, 104 from the aircraft 100 in some embodiments. To attach the boom 103, 104, the bottom portion 640 of the boom 103, 104 is hooked around the leading edge of the wing 102 and pushed up to the underside of the wing 102 (step 701). The attachment points 630 are fastened to attach the boom 103, 104 to the wing 102 (step 702). The top portion 635 is then attached to the bottom portion 640 via fasteners or snap assembly (step 703). The aircraft 100 may perform its flight plan (704). Upon completion of the flight, the boom 103, 104 may be detached by first detaching the top portion 635, such as by unfastening it from the bottom portion 640 (step 705). The attachment points 630 are then unfastened to detach the boom 103, 104 from the wing 102 (step 706). The bottom portion 640 of the boom 103, 104 is then lowered off the underside of the wing 102 (step 707).

In an embodiment, aircraft 100 comprises a safety system 230 configured to detect when the rear propellers 115b, 116b are in a folded configuration and emit a signal upon the detection to allow a door of the aircraft to be opened. In one example, the safety system 230 is implemented in computing system 203 and may comprise hardware and/or software programs. The safety system 230 may determine that one or more propellers 110b, 111b, 115b, 116b have stopped spinning based on electrical signals from the front and rear motors 110a, 111a, 115a, 116a. Electrical signals may indicate for each motor 110a, 111a, 115a, 116a whether the motor is spinning or at rest. In alternative embodiments, sensors may be used to detect for each motor 110a, 111a, 115a, 116a whether the motor is spinning or at rest and send a corresponding signal to the safety system 230. Upon receiving the indication that the motor 110a, 111a, 115a, 116a is at rest, the safety system 230 may determine that the respective propeller 110b, 111b, 115b, 116b is in a folded configuration due to the spring loaded auto-folding mechanism. In one example, the safety system 230 controls whether the rear door 620 may be opened. Alternatively, the safety system 230 may control whether the front door 610 may be opened.

In one embodiment, the safety system 230 prevents the rear door 620 from being opened when the rear propellers 115b, 116b are rotating and unfolded and allows the rear door 620 to be opened when the rear propellers 115b, 116b are stopped and folded. Alternatively, the safety system 230 may prevent either door 610, 620 from being opened when any of the propellers 110b, 111b, 115b, 116b are rotating and unfolded and allow the door to be opened when all the propellers 110b, 111b, 115b, 116b are stopped and folded. The safety system 230 may automatically lock one or more of doors 610, 620 with a safety lock while one or more of the propellers 110b, 111b, 115b, 116b are rotating and unfolded, by sending an electrical signal to the door to activate an automatic safety lock. To unlock one or more of doors 610, 620, the safety system 230 may send an electrical system to deactivate the automatic safety lock. The doors 610, 620 may include an emergency override that the pilot, passengers, or ground personnel may use to override (e.g., deactivate) the automatic safety lock to unlock the door and allow it to be opened even though one or more of propellers 110b, 111b, 115b, 116b are rotating and unfolded. Doors 610, 620 may also include a manual lock for locking or unlocking the door, or other automatic locks configured to apply to other conditions.

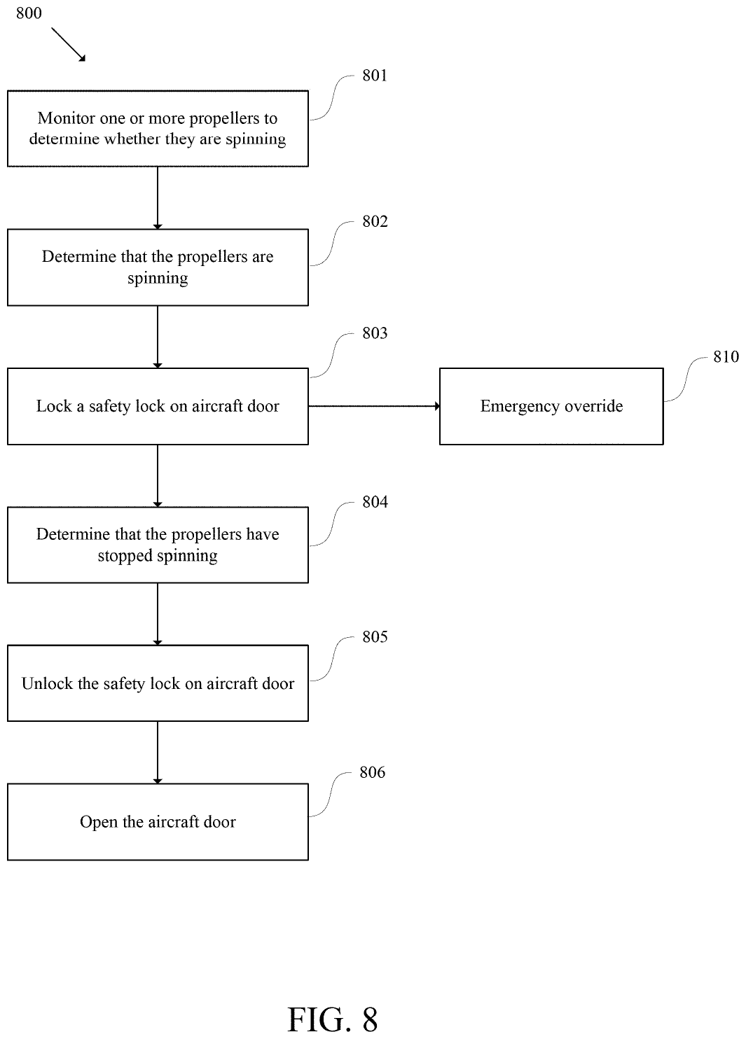

FIG. 8 illustrates an exemplary method 800 that may be used by a safety system 230 to automatically lock and unlock a safety lock of the aircraft 100 in some embodiments. The safety system 230 monitors one or more propellers to determine whether they are spinning (step 801). The safety system 230 determines that the propellers are spinning (step 802). In response, the safety system 230 locks a safety lock on an aircraft door (step 803). At any time, an emergency override may be activated to unlock the safety lock and open the aircraft door (step 810). Once the aircraft 100 has completed its flight, the safety system 230 continues to monitor the propellers and determines that the propellers have stopped spinning (step 804). The safety system 230 unlocks the safety lock on the aircraft door (step 805). The aircraft door may then be opened (step 806).

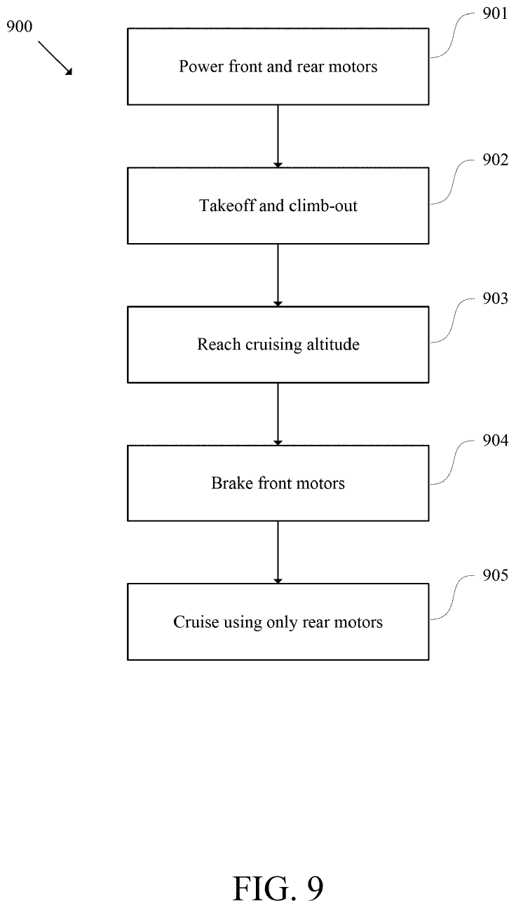

FIG. 9 illustrates an exemplary method 900 that may be used for an aircraft 100 to takeoff and climb-out to cruising altitude. An aircraft 100 on the ground prepares for takeoff, and the front and rear motors 110a, 111a, 115a, 116a are powered (step 901). Using the propulsion of the motors, the aircraft 100 takes off and climbs-out (step 902). Flaps may be partially deployed in this phase to generate lift, as well as other configurations typical of takeoff and climb-out. A cruising altitude is reached (step 903). At this point, the aircraft 100 may be at a cruise speed where the rear motors 115a, 116a may be more efficient, such as due to a steeper blade pitch of the propellers. The front motors 110a, 111a are then braked (step 904). The front motors 110a, 111a stop their rotation and the front propellers 110b, 111b fold automatically via the spring-loaded folding hinge. The aircraft 100 cruises using only the rear motors (step 905).

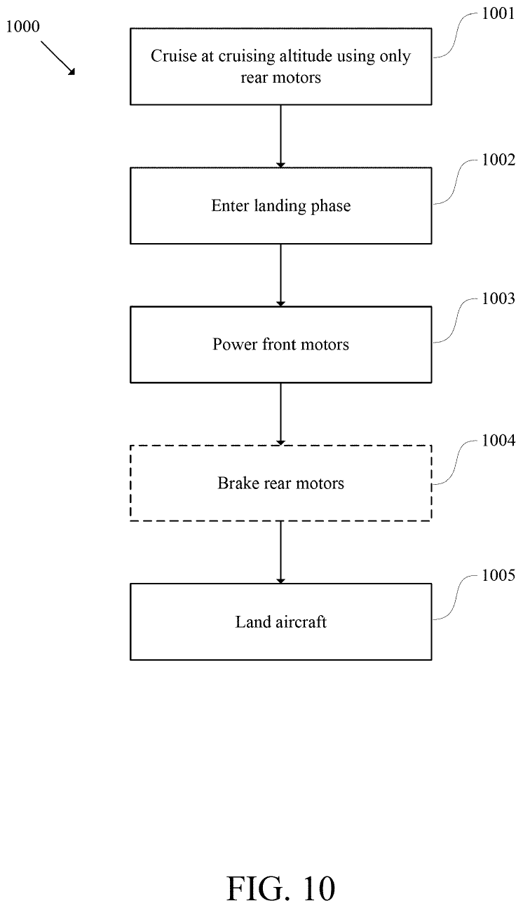

FIG. 10 illustrates an exemplary method 1000 that may be used for an aircraft 100 to land from a cruising altitude. An aircraft 100 cruises at cruising altitude using only the rear motors 115a, 116a while the front motors 110a, 111a are inactive and the front propellers 110b, 111b are in a folded configuration (step 1001). Aircraft 100 approaches its destination and enters a landing phase of flight (step 1002). Front motors 110a, 111a are powered causing the propellers 110b, 111b to unfold to their full extent (step 1003). The front motors 110a, 111a may be more efficient at the lower speeds typical of landing, such as due to a shallower blade pitch of the propellers. Optionally, the rear motors 115a, 116a may be actively braked, if it is desired to land with only the front motors 110a, 111a (step 1004). In step 1004, the rear motors 115a, 116a stop their rotation and the rear propellers 115b, 116b fold automatically via the spring-loaded folding hinge. Flaps may be deployed to increase drag, as well as other configurations typical of landing. The aircraft 100 lands (step 1005).

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. An aircraft comprising:
a fuselage;
one or more wings coupled with the fuselage;
a pair of booms attached to the one or more wings, each boom having a front end coupled with a front propulsion system and a rear end coupled with a rear propulsion system;
each front propulsion system comprising a front motor coupled with a foldable front propeller in a tractor configuration; and
each rear propulsion system comprising a rear motor coupled with a foldable rear propeller in a pusher configuration.

2. The aircraft of claim 1, wherein the blade pitch of the foldable front propellers is shallower than the blade pitch of the foldable rear propellers.

3. The aircraft of claim 2, wherein both the front propulsion systems and rear propulsion systems are configured to be powered during takeoff and climb-out and only the rear propulsion systems are configured to be powered during cruise.

4. The aircraft of claim 3, wherein only the front propulsion systems are configured to be powered during landing.

5. The aircraft of claim 1, wherein each front motor is inline with the corresponding rear motor on the respective boom.

6. The aircraft of claim 1, wherein each boom further comprises an air cooling system including an air cooling path running from the front motor of the boom through a support tube to the rear motor of the boom.

7. The aircraft of claim 1, wherein each boom is removable from the one or more wings.

8. The aircraft of claim 1, wherein each boom comprises a top portion and a bottom portion, the bottom portion is attached to the underside of the one or more wings, and the top portion is coupled with the top side of the one or more wings and the bottom portion of the boom.

9. The aircraft of claim 1, wherein the front end of each boom has a diameter that is the same size or smaller than the diameter of the front motor and the rear end of each boom has a diameter that is the same size or smaller than the diameter of the rear motor.

10. The aircraft of claim 1, further comprising:
a safety system configured to detect when the rear propellers are in a folded configuration and emit a signal upon the detection to allow a door of the aircraft to be opened.

11. A method of operating an aircraft comprising:
flying an aircraft on a flight path, wherein the aircraft comprises:
a fuselage;
one or more wings coupled with the fuselage;
a pair of booms attached to the one or more wings, each boom having a front end coupled with a front propulsion system and a rear end coupled with a rear propulsion system;
each front propulsion system comprising a front motor coupled with a foldable front propeller in a tractor configuration; and
each rear propulsion system comprising a rear motor coupled with a foldable rear propeller in a pusher configuration.

12. The method of claim 11, wherein the blade pitch of the foldable front propellers is shallower than the blade pitch of the foldable rear propellers.

13. The method of claim 12, further comprising:
flying the aircraft in takeoff, climb-out, and cruise phases of flight;
powering both the front propulsion systems and rear propulsion systems during takeoff and climb-out phases;
powering only the rear propulsion systems during the cruise phase.

14. The method of claim 13, further comprising:
flying the aircraft in a landing phase of flight;
powering only the front propulsion systems during the landing phase.

15. The method of claim 11, wherein each front motor is inline with the corresponding rear motor on the respective boom.

16. The method of claim 11, wherein each boom further comprises an air cooling system including an air cooling path running from the front motor of the boom through a support tube to the rear motor of the boom.

17. The method of claim 11, wherein each boom is removable from the one or more wings.

18. The method of claim 11, wherein each boom comprises a top portion and a bottom portion, the bottom portion is attached to the underside of the one or more wings, and the top portion is coupled with the top side of the one or more wings and the bottom portion of the boom.

19. The method of claim 11, wherein the front end of each boom has a diameter that is the same size or smaller than the diameter of the front motor and the rear end of each boom has a diameter that is the same size or smaller than the diameter of the rear motor.

20. The method of claim 11, wherein the aircraft further comprises a safety system configured to detect when the rear propellers are in a folded configuration and emit a signal upon the detection to allow a door of the aircraft to be opened.
